(19) United States
(12) Patent Application Publication
(10) Pub. No.: US 2012/0096019 A1
(43) Pub. Date: Apr. 19, 2012

(54) LOCALIZED AND CULTURAL DOMAIN NAME SUGGESTION

(76) Inventors: Ramesh Kumar MANICKAM, Bangalore (IN); Manish Kumar Maheshwari, Bangalore (IN); Ashishkumar Namdev Tadose, Bangalore (IN)

(21) Appl. No.: 13/048,340

(22) Filed: Mar. 15, 2011

(30) Foreign Application Priority Data
Oct. 15, 2010 (IN) 3049/CHE/2010

(51) Int. Cl. G06F 17/30

(52) U.S. Cl. 707/767; 707/772; 707/E17.014

(57) ABSTRACT

Suggested domain names are generated based upon regional, cultural and other information received from a user. The user input is correlated against terms in a localized name suggestion database to identify terms that are regionally and/or culturally relevant to the user. Candidate domain names are generated based upon the user input, the terms derived from the database and related terms such as synonyms. The candidate localized names that are available for registration are sent to the user, which can select one or more to be registered.

### BACKGROUND OF THE INVENTION

The Internet enables a user of a client computer system to identify and communicate with millions of other computer systems located around the world. A client computer system can identify each of these other computer systems using a unique numeric identifier for that computer called an Internet Protocol (“IP”) address. When a communication is sent from a client computer system to a destination computer system, the client computer system typically specifies the IP address of the destination computer system in order to facilitate the routing of the communication to the destination computer system. For example, when a request for a website is sent from a browser to a web server over the Internet, the browser ultimately addresses the request to the IP address of the server. IP addresses are a series of numbers separated by periods and can be hard to remember for users.

The Domain Name System (DNS) has been developed to make it easier for users to remember the addresses of computers on the Internet. DNS translates (“resolves”) a unique alphanumeric domain name that is associated with a destination computer into the IP address for that computer. Thus, a user who wants to visit the VeriSign website need only remember the domain name “versign.com” rather than having to remember the VeriSign web server IP address, such as 65.205.249.60.

A new domain name can be registered by a user through a domain name registrar. The user submits to the registrar a request that specifies the desired domain name. The registrar can consult a central registry that maintains an authoritative database of registered domain names to determine if a domain name requested by a user is available for registration, or if it has been registered by another. If the domain name has not already been registered, the registrar can indicate to the user that the requested domain is available for registration. The user can submit registration information and a registration request to the registrar, which can cause the domain to be registered for the user at the registry. If the domain is already registered by another, the registrar can inform the user that the domain is not available.

Many desirable domain names have already been registered and are no longer available. Thus, a user may have to submit several domain name registration requests before finding a domain name that is available. There may be suitable alternative domain names that are that unregistered and available, but which of user is unaware. Further, there may be domain names available to register, of which a user is not aware when selecting a domain name, but which would be of interest to the user. What is needed is an effective system for proposing suitable, unregistered alternative domains that are available for registration, based upon a requested domain that is unavailable, one or more terms or phrases that may be submitted by a user, and/or other data. Such a system should propose alternative domain names that are appealing to the user and that are responsive to the user's needs.

### BRIEF SUMMARY OF THE INVENTION

The invention provides advantageous methods and systems for generating suggested domain names. The methods and systems may provide suggested domain names based upon regional, cultural, and/or other information received from a user. User input may be correlated against terms in a localized suggestion database to identify terms that are regionally and/or culturally relevant to the user. Additional features, advantages, and embodiments of the invention may be set forth or apparent from consideration of the following detailed description, drawings and claims. Moreover, it is to be understood that both the foregoing summary of the invention and the following detailed description are exemplary and intended to provide further explanation without limiting the scope of the invention as claimed.

### BRIEF DESCRIPTION OF THE DRAWINGS

FIG. 1 shows an example process for generating suggested domain names according to embodiments of the invention.

FIG. 2 shows an example user interface for receiving a user selection of a business category according to an embodiment of the invention.

FIG. 3 shows an example user interface for receiving a user selection of a desired or related geographical region according to an embodiment of the invention.

FIG. 4 shows an example user interface for receiving a user indication of a business or personal name according to an embodiment of the invention.

FIG. 5 shows an example user interface for receiving one or more keywords from the user according to an embodiment of the invention.

FIG. 6 shows an example user interface for requesting suggested domains according to an embodiment of the invention.

FIG. 7 shows an example user interface for selecting and/or editing one or more suggested domains according to an embodiment of the invention.

FIG. 8 shows an example user interface for indicating domain name availability to the user according to an embodiment of the invention.

FIG. 9A shows an example user interface that illustrates an optional user-selectable technique for generating suggested domain names according to an embodiment of the invention.

FIG. 9B shows an example user interface that illustrates suggested domain names that result when the user indicates that he is interested in numerology-related domain names according to an embodiment of the invention.

FIG. 10 shows an example of a localized name suggestion engine according to an embodiment of the invention.

### DETAILED DESCRIPTION OF THE INVENTION

It is understood that the invention is not limited to the particular methodology, protocols, topologies, etc., as described herein, as these may vary as the skilled artisan will recognize. It is also to be understood that the terminology used herein is used for the purpose of describing particular embodiments only, and is not intended to limit the scope of the invention. It also is to be noted that as used herein and in the appended claims, the singular forms “a,” “an,” and “the” include the plural reference unless the context clearly dictates otherwise.

Unless defined otherwise, all technical and scientific terms used herein have the same meanings as commonly understood by one of ordinary skill in the art to which the invention pertains. The embodiments of the invention and the various features and advantageous details thereof are explained more fully with reference to the non-limiting embodiments and/or illustrated in the accompanying drawings and detailed in the following description. It should be noted that the features illustrated in the drawings are not necessarily drawn to scale, and features of one embodiment may be employed with other embodiments as the skilled artisan would recognize, even if not explicitly stated herein.

Particular methods, devices, and materials are described, although any methods and materials similar or equivalent to those described herein can be used in the practice or testing of the invention. All references referred to herein are incorporated by reference herein in their entirety.

Various techniques may be used for generating suggested domain names. For example, synonyms of a desired domain or a portion of the desired domain may be used as alternative domains. These techniques may exclude some types of domains that a user may be interested in obtaining, because they are limited in context and by the language in which the techniques operate. For example, a synonym-type alternative domain system may only be able to offer synonym-based domains in a single language, whereas the user may be interested in related domains in other languages as well. Users also may find it helpful for the system to suggest domain names based on, for example, their business name, business field, or other information, without the user providing an initial desired domain name.

Systems and methods according to embodiments of the invention provide for generation of domain names in one or more languages that may be different from the language in which a suggested or desired domain is provided. More specifically, embodiments may provide for generation of domains that can be easily recognized by people from particular geographic regions or cultural backgrounds who understand specific languages apart from English. In some cases, a particular cultural background may be tied to a certain region. For example, Hindu culture may be primarily associated with the Indian subcontinent. In other cases, a cultural background may not be as closely tied to a region. For example, British culture is known in many different regions of the world beyond Great Britain, including the Indian subcontinent, Canada, New Zealand, etc.

Regionally and/or culturally relevant domain names may be generated from a collection of terms that are derived from one or more languages and considerations that are associated with a given region or culture. For example, the terms may be derived from Hindi and Hindu cultural considerations, such as terms considered to be auspicious in the Hindu culture, numbers considered to be lucky, etc. These terms can be used as-is for use in Interationalized (e.g., non-RACE encoded) Domain Names (IDNs.) or transliterated to a another language, such as English. The English transliterations can represent, equivalent regional/cultural language words.

In other embodiments, domain names may be generated that would be perceived as auspicious based on numerology, religious, or other geographic or cultural considerations.

For example, a business may have a company name of “Ramesh Clothing.” A name suggestion system or method according to an embodiment of the invention may suggest the domain name RameshVastra.com as suitable for the business. “Vastra” is an English-language rendition of a Hindi word that refers to cloth or clothing, so such a domain may be contextually desirable because it would be readily identifiable for people who understand Hindi.

Embodiments of the invention may be particularly well-suited to locations or populations in which a number of languages and/or distinct cultures are present. In many cases common or desired English business domain names may already be registered, so a user find it advantageous to use a localized suggestion engine in accordance with embodiments of the invention that can propose, for example, an anglicized rendition of localized and regional terms that align with the business category and/or the prospective market for a product being sold in connection with the domain. Other examples of types of domains that may be of interest include location-related, similar sounding names in a single language or multiple languages, domains that include culturally appealing terms, e.g. names based on numerology, divinity, or lucky numbers, and the like.

Embodiments of the invention may use various techniques to generate suggested domain names. One technique makes use of transliteration to generate a suggested domain name as a combination of a provided term, business, owner, or user name and an Anglicized rendition of a related regional or local term. For example, a local term related to a particular business category may be used as part of a suggested domain name.

In another technique, demographic information may be used in the generation of a suggested domain name. The demographic information may be based on, for example, the user's location, a location specified by the user, a location derived from geolocation data provided in connection with a mobile device associated with the user, or a location specific to the website or other provider hosting the domain name suggestion service. In some cases, terms from regional languages in that location may be anglicized or otherwise included in the suggested domain names.

In another technique, social and/or cultural terms may be used to generate suggested domain names. For example, the auspiciousness of a term related to a domain name requested by a user may be considered when suggesting domain names. Terms with particularly high relevance in numerology, divinity, and the like may be preferred when suggesting domain names. In some configurations suggested domain names may be ranked in preference based upon the numerological, religious, or similar significance of a term or terms in the domain names. For example, a suggested domain name may include a “lucky number” combination of a business name provided by a user.

In a specific example, a user may provide the following information:

Business category: Garments

Business Name/Owner Name: Aishwarya

Lucky nr: 7

Location: North India or Delhi

Keywords: Saree

In response, a system according to an embodiment of the invention may use one or more techniques to generate suggested domain names. Each technique may be used individually, or they may be used in any combination, such as by combining the results of various techniques into one or more suggested domain names.

According to one technique, domain names may be generated using localization and/or transliterations. Based on the business category and location provided by the user, localized results are generated. Suggested domain names may include combination of transliterations in a regional language and the business name and/or keywords. Using the example input, suggested domains may include the business or owner name combined with category oriented words such as “cloth,” “dress,” or a specific dress name. Other suggested domains may be generated as combinations of keywords and transliteration of category-related words such as “shop” or region-specific or -oriented words. As specific examples, using the user input above, the system may select terms such as kapda, vastra, resham, salwar, and paridhan, which are Hindi words referring to cloth, a dress, silk, a specific type of dress, and dress, respectively. The resulting suggested domain names may include the following:

AishwaryaKapda.com

AishwaryaVastra.com

AishwaryaSalwar.com

AishwaryaResham.com

AishwaryaParidhan.com

SareeKapda.com

SareeVastra.com

SareeResham.com

According to another technique, domain names may be generated using region common words. Based on the business category and related regional words, various combinations may be generated. Using the example input above, suggested domains may include the business category “garments,” the keyword “saree,” or other related terms. Suggested domains also may include regional words or terms, such as dukan, masti, wala, apna, and hamara, which are Hindi words referring to shop, fun, a profession (e.g., dukanwala is a shopkeeper), my, and our, respectively. The resulting suggested domains may include the following:

SareeDukan.com

SareeMasti.com

Sareewala.com

ApnaSaree.com

HamaraSaree.com

According to another technique, divine or religious terms may be used to generate suggested domain names, and may be used in combination with the user provided input. For example, Om, Sri, and Shri are auspicious religious terms in Hindi and other Indian languages, and Sai is the name of a diety. Using the input above, specific examples of resulting suggested domains may include:

OmSaree.com

SriSaree.com

SaiSaree.com

According to another technique, the user's lucky number, birth date, or other concept from numerology or astrology and the like may be used. As a specific example, the user input above may result in the following domain names:

Aishwaryaa.com

Aishwaryas.com

Aishwaryaj.com

According to another technique, similar-sounding words in a particular language may be used. Although domains may be generated using Anglicized terms and/or using an English or ASCII-based alphabet, the terms may be generated using the pronunciation that would be applied in another language. For example, using the example business name above, the system may generate domain names such as the following:

Ayzhwarya.com

Aeeshwarya.com

Aaishwarya.com

Aishwaryaa.com

Aeeshwaryaa.com

In general, the various techniques described above may be used in any suitable combination, and for any available top-level domain. Thus, different combinations than those specifically listed above may be used, as well as other similar combinations. The techniques may be applied to languages other than those specifically described. For example, similar suggestions can be built for different geographical regions, geographies, regions, states, countries, and the like, by using appropriate regional languages and/or dialects for transliteration. For example, a user that selects a finance-related category in Germany may be provided with suggested domain name terms such as GoodGeld, NiceZahlungsmittel, or MyGeld. Similarly, a user that selects a food category in Spain may be provided with suggested domain name terms including TastyLosAlimentos, GoodPasto, and the like.

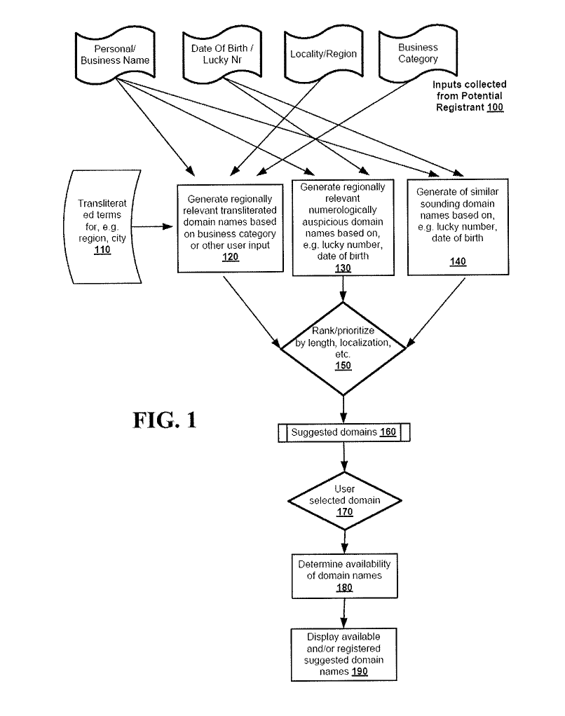

FIG. 1 shows an example process according to embodiments of the invention. At 100, various inputs may be collected from a user. The input may include a personal and/or business name, date of birth, lucky number, locality, region, business category, keyword(s), or other similar data. At 110, transliterated terms may be generated for one or more terms in or related to the user input. The terms may be obtained from, for example, a database that links appropriate transliterated terms with the terms and types of terms that it is expected users will provide. At 120, 130, and 140, one or more various techniques may be applied to generate suggested domain name terms as previously described. The techniques may include, for example, transliterated terms based on the business category or other input at 120, numerologically or astrologically auspicious terms at 130, and lucky numbers or other similar terms at 140. The terms generated at 120, 130, and/or 140 may be combined to produce a second level domain name, which may be combined with any suitable top-level domain, including but not limited to .com, .net, and the like.

At 150, the generated domain name portions may be ranked or prioritized. For example, shorter domain names may be ranked more highly, i.e., considered more likely to be desirable to the user, than longer domains. Other factors, such as the degree of localization of the domain name, also may be used to rank the generated domain names. For example, if the system is intended to serve a specific locale, then more localized domains may be ranked higher than more general domains. Similarly, if the system is intended to serve a broader audience or region, less-localized domain names, or domains whose localization would be appreciated by a relatively large number of cultures or groups, may be preferred.

At 160, the domain name portions generated at 120, 130, and/or 140 may be used to generate suggested domains for presentation to the user. If the user has indicated a desired or preferred domain name or domain name portion at 170, the user's preference also may be included in the set of suggested domain names. At 180, the system may query one or more domain name registries to determine if the generated and/or user-provided domain names are available to be registered in the DNS. At 190, the system may provide a list of the available and/or registered domain names to the user, and receive a selection of one or more domain names the user wishes to register. The system also may interface with a domain name registration system or process as is known in the art, to register the selected domain name(s) with the appropriate registry.

It will be understood that not all the steps shown in FIG. 1 need be performed in every embodiment, and that various steps may be omitted. For example, the various technique described at 120, 130, and 140 may not each be performed. As another example, complete domain names may be ranked as described at 150 after the domains are generated at 160. Other variations will be readily appreciated by one of skill in the art.

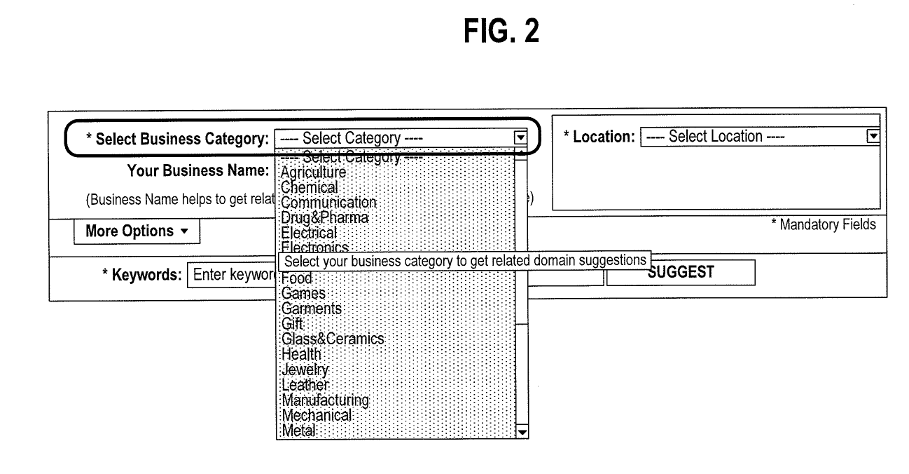

FIGS. 2-9 show example user interfaces for receiving user input and providing suggested domain names according to embodiments of the invention. FIG. 2 shows an example user interface for receiving a user selection of a business category. In the example, the user selects the “electrical” category.

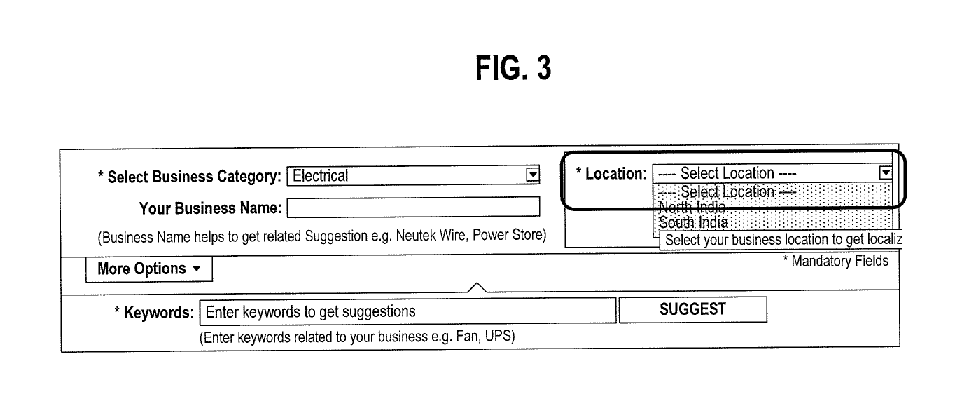

FIG. 3 shows an example user interface for receiving a user selection of a desired or related geographical region. The regions provided may be linked to the various transliteration and other context-related terms stored in a database of potential domain name portions. The illustrated interface allows a user to choose between north and south India, each of which may have, for example, different cultural or religious conventions that would suggest the use of different domain name portions in generating suggested domain names.

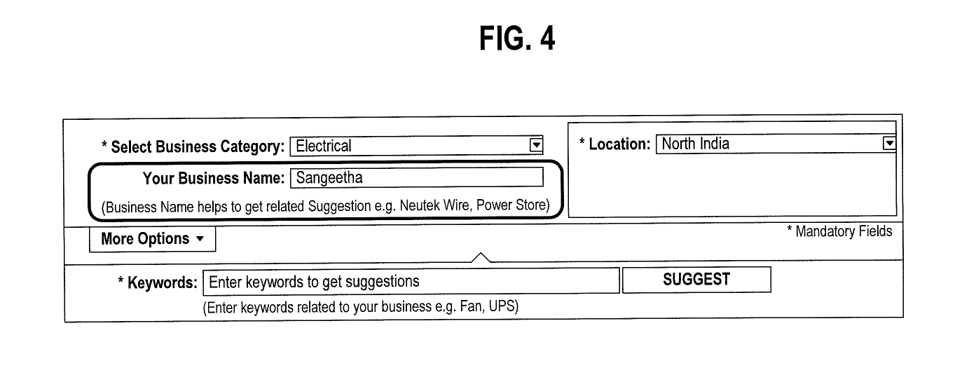

FIG. 4 shows an example user interface for receiving a user indication of a business or personal name associated with the domain name request. In the example, the user provides the name of a business, “Sangeetha,” for which a domain name is desired.

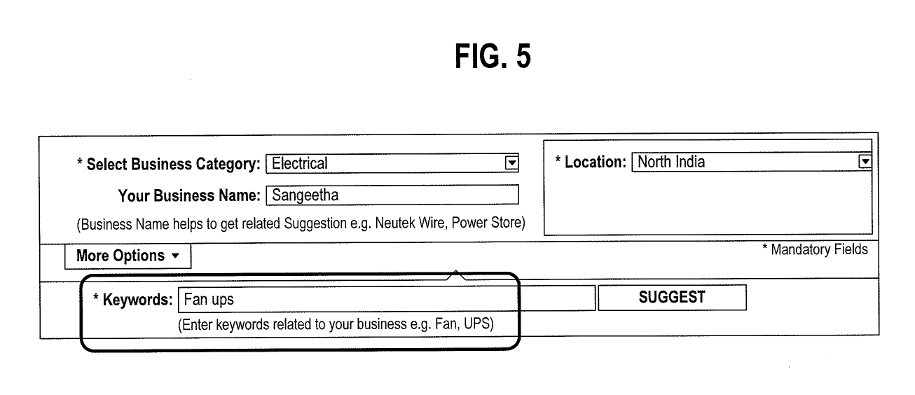

FIG. 5 shows an example user interface for receiving one or more keywords for the business from the user. In the example, the user provides the terms “fan” and “UPS,” which relate to the focus of the business. In the example illustrated in FIGS. 3-5, the business for which a domain is desired may be a computer part supply business, specializing in power and cooling solutions.

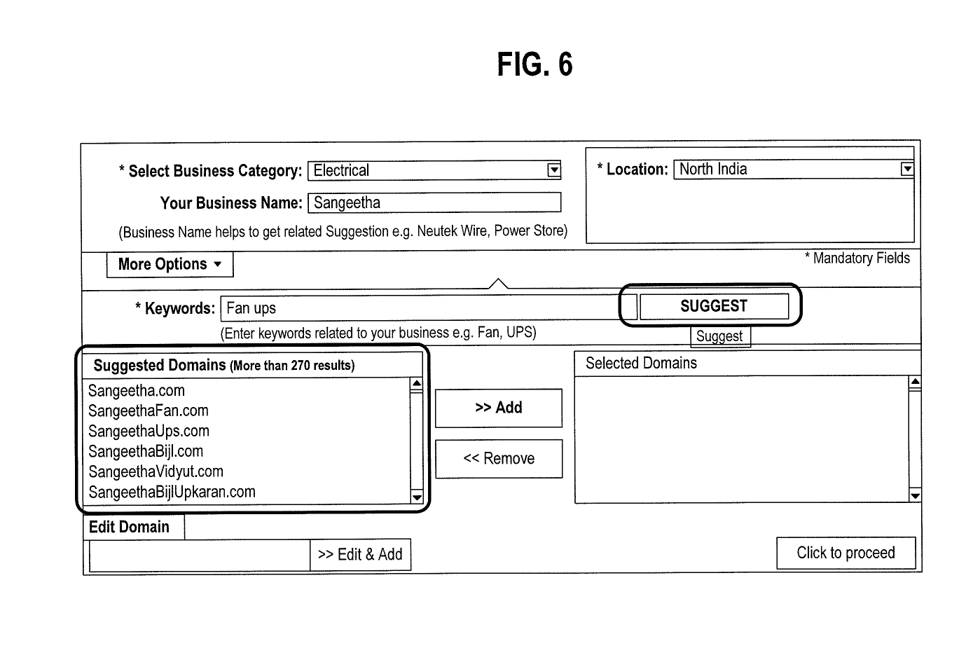

FIG. 6 shows an example user interface for requesting suggested domains. Upon the user selecting the “suggest” button, the system may generate one or more suggested domains as previously described. In the example, the system has provided the domains Sangeetha.com, SangeethaFan.com, SangeethaUps.com, SangeethaBiji.com, SangeethaVidyut.com, and SangeethaBijliUpkaran.com, and indicates that there are over 270 total suggested domain names that have been generated. (Bijli, Vidyut, and Upkaran are the Hindi words for electricity, electrical or power, and appliances respectively)

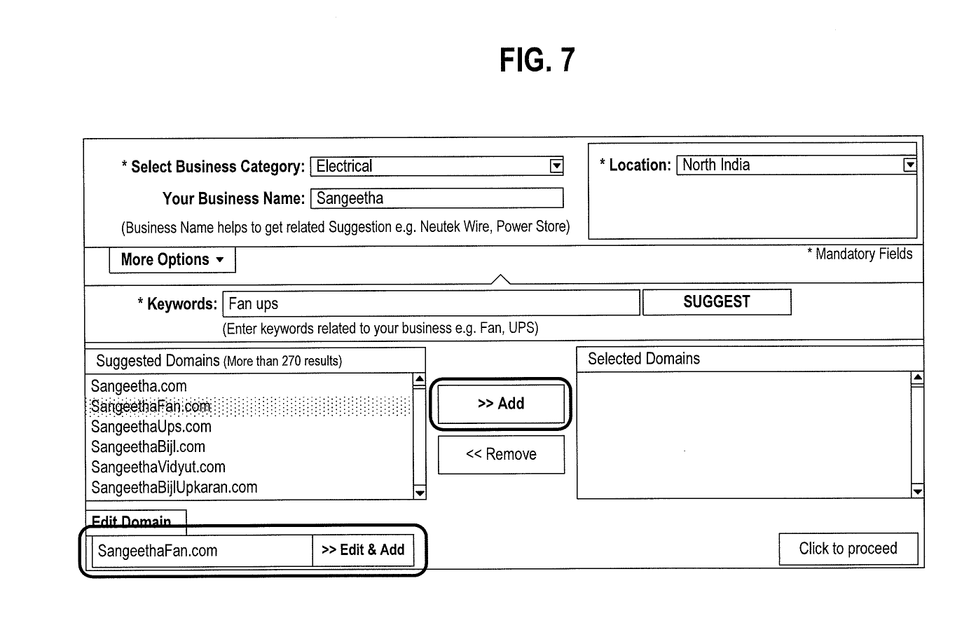

FIG. 7 shows an example user interface for selecting and/or editing one or more of the suggested domains. By selecting the “Add” button, a user may add a suggested domain to the list of domains selected by the user. The user also may be provided with a mechanism for editing the suggested domain before adding it.

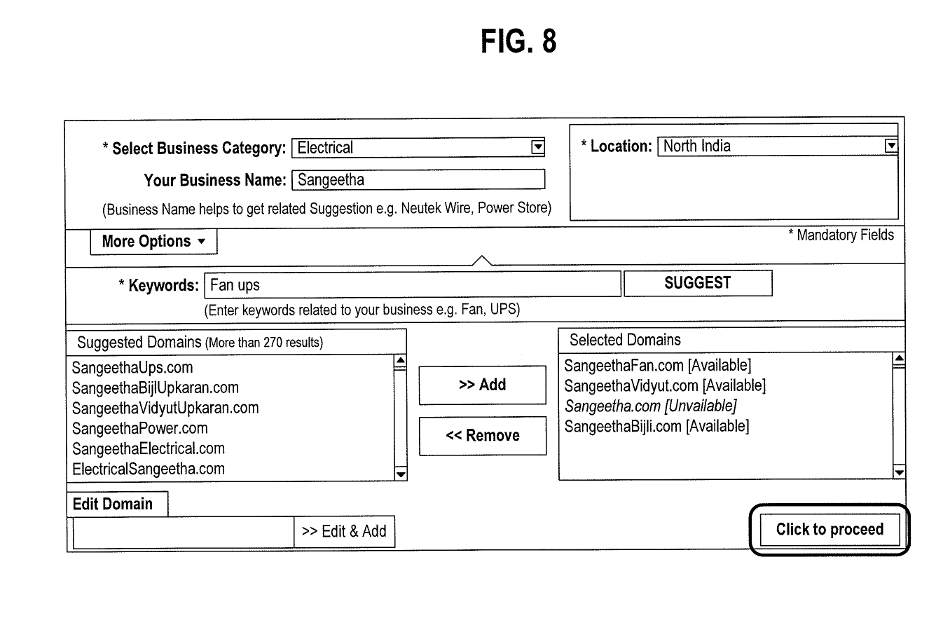

FIG. 8 shows an example user interface for indicating domain name availability to the user. In the example, SangeethaFan.com, SangeethaVidyut.com, and SangeethaBijli are available, and are shown in bold, green text. Sangeetha.com is not available to be registered, and is shown in grey italic text. Other visual arrangements may be used to indicate the availability or non-availability of a domain name.

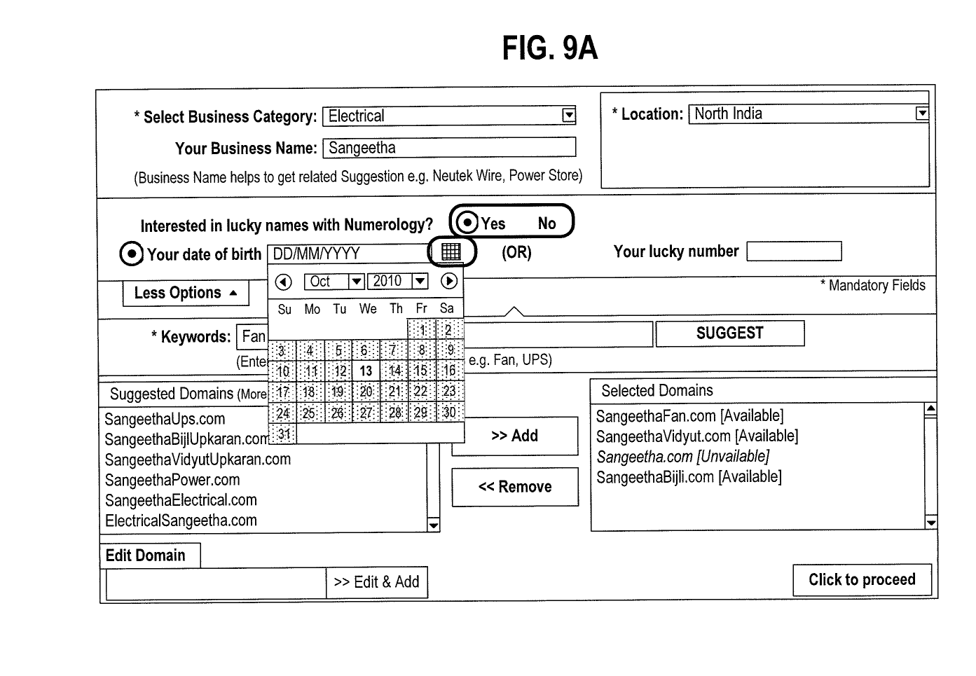

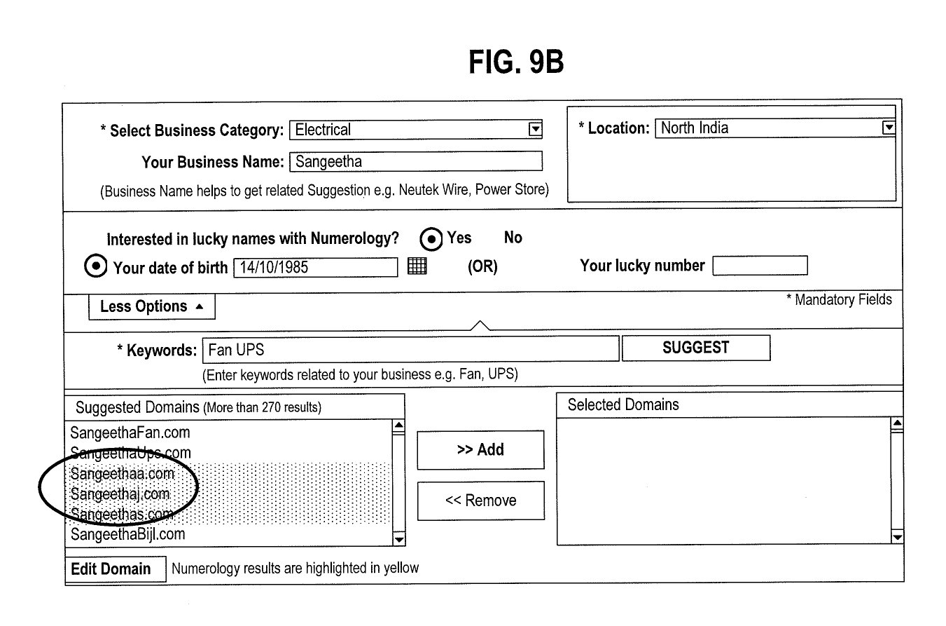

FIG. 9A shows an example user interface that illustrates an optional technique, selectable by the user, for generating suggested domain names. In this example, the user may indicate whether or not he is interested in numerology-related domain names and, if so, may provide his date of birth and/or lucky number. If the numerology option is selected, the system will use this data when generating suggested domain names, as previously described.

FIG. 9B shows an example user interface that illustrates suggested domain names that result when the user indicates that he is interested in numerology-related domain names as described with respect to FIG. 9A. In the example, the system generates and includes several suggest domain names based upon the user's birth date as provided by the user.

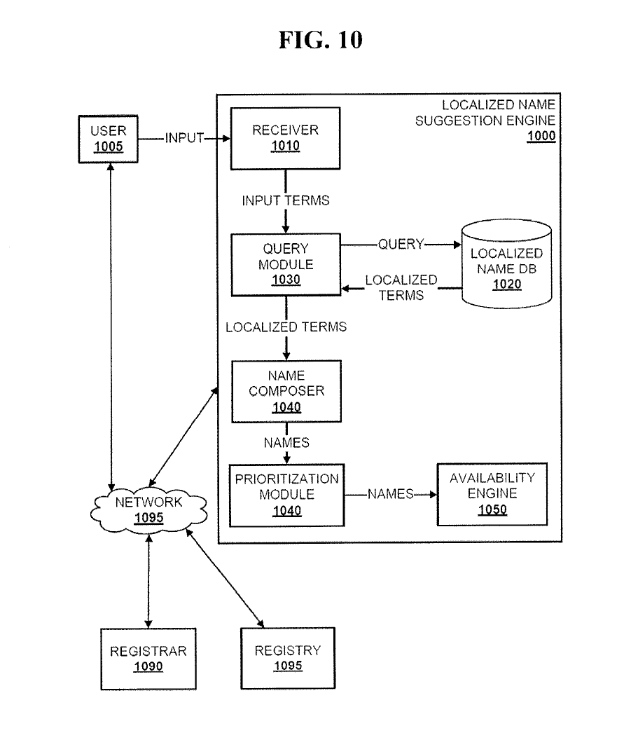

FIG. 10 shows an example system in accordance with an embodiment of the invention. The system may include a localized name suggestion engine 1000 in communication with a registrar server 1090 via a network 1095, such as the Internet. The localized name suggestion engine may also be implemented at the registrar server. A user is also in communication with the registrar, e.g., via a network such as the Internet. The registrar can be in communication with one or more registries for one or more Top Level Domains (TLDs).

The localized name suggestion engine can be in communication with and/or include a localized name suggestion database 1020 that contains terms and/or phrases that are correlated with one or more regional and/or cultural designation. For example, the term “VASTRA” may be correlated with the regional and cultural designations “India” and “Hindu”. It may also be correlated with various descriptors, such as “clothing”, “tailor” and “dress.”

In accordance with an embodiment of the present invention, the localized name suggestion engine may include a receiver 1010 for receiving input from the user regarding a desired domain name, a regional preference and a business category. The receiver may transmit this information to a query module 1030 that formulates queries that are sent to the localized name database to identify terms and phrases that may be desirable in a domain name for the user. The queries may be based upon the regional preference, business category and other information obtained from the user. The query module may transmit the results of the query to a name composer subsystem 1040 that may generate candidate name suggestions based upon the data received from the query module. For example, the name composer subsystem may generate candidate names based upon the business category, regional preference, lucky words and phrases, user input, etc. The name composer subsystem may communicate some or all of the generated candidates to the query module to serve as the basis of additional queries to the localized name suggestion database, the results of which may be returned to the name composer subsystem. This iterative process may generate additional candidate terms that may be useful in a domain name for the user. The candidates generated by the name composer subsystem may also include all or part of one or more domain names submitted by the user that may be unavailable for registration.

The name composer subsystem may also generate related terms based upon candidate names that it generates and/or the data received from the query module. These related terms may include synonyms, homonyms, antonyms and the like. The name composer subsystem may send the candidate names to a prioritization module 1060 that prioritizes or rates the candidate names based upon a relevance rating determined by the prioritization module, the length of the candidate (shorter candidates may be prioritized as more potentially valuable than longer candidates), etc. The relevance rating may be determined by the strength of the correlation of terms in the candidate with the input provided by the user, e.g., business category, keywords, etc.

An availability engine 1050 may receive candidate domain names from, for example, the name composer and/or the prioritization module. The availability engine may be in communication with one or more registries 1095 and determines which of the more highly prioritized candidate domain names are available for registration. It sends those which are presently available to the transmitter, which may send them to the registrar for display to the user or directly to the user.

In accordance with embodiments of the present invention, alternative names may be generated based upon data provided by devices or third parties. For example, regional information may be derived from geolocation data automatically provided by a fixed computer or a mobile device utilized by the user. Likewise, background information regarding the user, the user's business, location, culture, etc., may be provided based upon a profile of the user stored at the registrar.

In an embodiment of the invention, internationalized domain names may be suggested in addition to or instead of the ASCII-type examples described above. For example, domains in specific languages or corresponding to RACE, punycode, or other encoding technique may be suggested.

In an embodiment of the invention, help information, domain name suggestions, or other data may be provided dynamically, i.e., as the user provides data to the system. For example, as the user provides additional keywords, additional suggested domain names may be displayed to the user.

Embodiments of the invention may include interfaces for other systems, to allow for domain name suggestion by way of interfaces other than the main user interface provided by the suggestion system. For example, the system may provide an API that is accessible by other domain name suggestion systems. As another example, the system may include a mobile native application, mobile web application, SMS interface, or other component to allow for access by a mobile device.

Any of the candidate or suggested domain names described herein may be provided to the user as alternative domain names to an initial domain name requested by the user. For example, domain name systems as described herein may be incorporated into a domain name registration system, in which a user provides an initial desired domain name and, if the domain name is not available, the system provides suggested alternative domains. Alternatively or in addition, the suggested domain names may be provided without receiving an initial desired domain name from the user.

Various embodiments of the invention may include or be embodied in the form of computer-implemented processes and apparatuses for practicing those processes. Embodiments also may be embodied in the form of a computer program product having computer program code containing instructions embodied in tangible media, such as floppy diskettes, CD-ROMs, hard drives, USB (universal serial bus) drives, or any other machine readable storage medium, wherein, when the computer program code is loaded into and executed by a computer, the computer becomes an apparatus for practicing the invention. Embodiments of the invention also may be embodied in the form of computer program code, for example, whether stored in a storage medium, loaded into and/or executed by a computer, or transmitted over some transmission medium, such as over electrical wiring or cabling, through fiber optics, or via electromagnetic radiation, wherein when the computer program code is loaded into and executed by a computer, the computer becomes an apparatus for practicing the invention. When implemented on a general-purpose microprocessor, the computer program code segments configure the microprocessor to create specific logic circuits. In some configurations, a set of computer-readable instructions stored on a computer-readable storage medium may be implemented by a general-purpose processor, which may transform the general-purpose processor or a device containing the general-purpose processor into a special-purpose device configured to implement or carry out the instructions. Embodiments may be implemented using hardware that may include a processor, such as a general purpose microprocessor and/or an Application Specific Integrated Circuit (ASIC) that embodies all or part of the method in accordance with the present invention in hardware and/or firmware. The processor may be coupled to memory, such as RAM, ROM, flash memory, a hard disk or any other device capable of storing electronic information. The memory may store instructions adapted to be executed by the processor to perform the method in accordance with an embodiment of the present invention. For example, instructions may be executed on the processor to receive input from a user, query the localized name suggestion database, compose and prioritize candidate alternative domain names, determine which of the candidates are available for registration and send available candidates to the user.

Examples provided herein are merely illustrative and are not meant to be an exhaustive list of all possible embodiments, applications, or modifications of the invention. Thus, various modifications and variations of the described methods and systems of the invention will be apparent to those skilled in the art without departing from the scope and spirit of the invention. Although the invention has been described in connection with specific embodiments, it should be understood that the invention as claimed should not be unduly limited to such specific embodiments. Indeed, various modifications of the described modes for carrying out the invention which are obvious to those skilled in the relevant arts or fields are intended to be within the scope of the appended claims.

We claim:

1. A system for generating alternative candidate domain names for registration, comprising:
a receiver;
a localized name suggestion database that includes at least one record that correlates a localized term with one or more attributes including at least one from the group of: a business name, a business category, a region, a cultural designation and a keyword provided by a user;
a query module in communication with the receiver and the localized name suggestion database that receives user input from the receiver, formulates at least one query based upon the user input, sends the query to the localized name suggestion database and receives a response containing at least one localized term from the database;
a name composer subsystem that receives at least one localized term and user input from the query module and generates a candidate domain name based upon the localized term and the user input;
a prioritization module that receives a plurality of candidate domain names from the name composer subsystem and prioritizes the candidate names based at least upon the lengths of the candidate domain names;
an availability engine that receives at least one candidate domain name from the prioritization module and determines if the name is available for registration; and
a transmitter that receives an available candidate domain name from the availability engine and causes the name to be sent to the user.

2. The system of claim 1, wherein the localized term is a transliteration of a term provided by the user.

3. A method for generating candidate domain names, comprising:
receiving input from a user that includes at least one from the group of: a business name, a business category, a region, a cultural designation and a keyword provided by the user;
querying a localized name suggestion database based upon the user input, wherein the localized name suggestion database includes at least one record that correlates a term with at least one of a regional or cultural designation and at least one attribute;
identifying a localized term that is relevant to the user input by correlating the regional or cultural designation provided by the user with the cultural or regional designation contained in a record containing the term and correlating at least one from the group of a business name, a business category and a keyword provided by a user with at least one attribute contained in the record;
receiving a response that includes at least one localized term from the localized name suggestion database;
generating at least one candidate domain name based upon the user input and the localized term;
determining if the at least one a candidate domain name is available to be registered; and
if the name is available to be registered, causing the name to be sent to the user.

4. The method of claim 3, wherein the localized term is a transliteration of a term provided by the user.

5. A method comprising:
receiving input from a user;
identifying a localized term based upon the user input;
generating at least one candidate domain name based upon the user input and the localized term;
determining if the at least one candidate domain name is available to be registered; and
if the name is available to be registered, causing the name to be sent to the user.

6. The method of claim 5, wherein the user input includes at least one from the group of: a business name, a business category, a region, a cultural designation and a keyword provided by the user.

7. The method of claim 5, further comprising querying a localized name suggestion database based upon the user input to identify a record that correlates the localized term with the user input.

8. The method of claim 5, wherein the step of identifying the localized term comprises:
correlating a regional or cultural designation provided by the user with a cultural or regional designation contained in a database record containing the term; and
correlating at least one from the group of a business name, a business category and a keyword provided by a user with at least one attribute contained in the record.

9. The method of claim 5, wherein the localized term is a transliteration of a term provided by the user.

10. A domain name suggestion system comprising:
a localized name suggestion database that includes at least one record that correlates a localized term with one or more attributes including at least one from the group of: a business name, a business category, a region, a cultural designation and a keyword provided by a user;
a query module in communication with the localized name suggestion database that receives user input, formulates at least one query based upon the user input, sends the query to the localized name suggestion database and receives a response containing at least one localized term from the database;
a name composer subsystem that receives at least one localized term and user input from the query module and generates a candidate domain name based upon the localized term and the user input; and
a user interface that provides the candidate domain name to the user.

11. The system of claim 10, further comprising:
a prioritization module that receives a plurality of candidate domain names from the name composer subsystem and prioritizes the candidate names based at least upon the lengths of the candidate domain names.

12. The system of claim 10, further comprising:
an availability engine that receives at least one candidate domain name and determines if the name is available for registration.

13. The system of claim 10, wherein the localized term is a transliteration of a term provided by the user.

14. A system substantially as described and shown.

15. A method substantially as described and shown.
